(19) United States
(12) Patent Application Publication
(10) Pub. No.: US 2019/0259133 A1
(43) Pub. Date: Aug. 22, 2019

(54) MULTIPLE FRAME BUFFERING FOR GRAPHICS PROCESSING

(71) Applicant: VISTEON GLOBAL TECHNOLOGIES, INC., Van Buren Township, MI (US)

(72) Inventors: Remi Sigrist, Sophia-Antipolis (FR); Emmanuel Roncoroni, Sophia-Antipolis (FR); Olivier Bantiche, Sophia-Antipolis (FR)

(73) Assignee: VISTEON GLOBAL TECHNOLOGIES, INC., Van Buren Township, MI (US)

(21) Appl. No.: 16/404,167

(22) Filed: May 6, 2019

Related U.S. Application Data
(63) Continuation of application No. 15/437,238, filed on Feb. 20, 2017, now abandoned.
(60) Provisional application No. 62/297,492, filed on Feb. 19, 2016.

(51) Int. Cl. G06T 1/60; B60K 35/00

(52) U.S. Cl. CPC G06T 1/60; B60K 2370/52; B60K 35/00

(57) ABSTRACT

Disclosed herein are methods and systems for implement multiple frame buffers for a display system. The method and systems disclosed herein allow implementations where specific graphical assets may be rendered every frame, while other graphical assets may be rendered every other frame. The aspects disclosed herein allow existing graphical processors, including those implemented in the vehicular display space (i.e. instrument clusters) to be modified so as to allow for a display environment that is independent of lags and a non-smooth operation.

### CROSS-REFERENCE TO RELATED APPLICATION

This application claims benefit of U.S. application Ser. No. 15/437,238, entitled “MULTIPLE FRAME BUFFERING FOR GRAPHICS PROCESSING,” filed Feb. 20, 2017, which claims priority to U.S. Provisional Patent Application No. 62/297,492, filed Feb. 19, 2016, entitled “Multiple Frame Buffering for Graphics Processing,” now pending, all of which are hereby incorporated by reference in their entirety.

### BACKGROUND

Digital displays provide a medium in which lighted elements are employed to convey information to a viewer of the digital display. The digital displays may be employed in a variety of contexts and environment, such as a personal computer, a home, a vehicle, or the like.

The digital display may be coupled to a control system, such as a processor, or the like. The control system may receive instructions or information to convey via the digital display. The control system may be configured to translate (or render) the information onto the digital display.

The architecture of a sample digital display system and the electrical componentry to control and modify a digital display is shown below in FIG. 1. The system shown is exemplary and is used to illustrate a model form of implementing a display system.

FIG. 1 illustrates an example of a system 100 for graphics processing and rendering for an application, such as a display 150 for an instrument cluster. As shown, the display includes an image 151. The image 151 includes a background image 151a and a foreground image 151b (i.e. a telltale, pointer, or the like). While an automotive instrument cluster is employed for explanatory purposes, the concepts disclosed herein may be implemented with other types of displays and applications as well.

The display 150 is coupled to a graphics processor 110. The graphics processor 110 includes an instruction set 120 programmed to facilitate data being moved from component to component, and rendered via the graphics processor 110.

Also shown in FIG. 1 is an internal memory bank 130. The internal memory bank includes an internal VRAM 131, an internal FLASH 132, and access to the external FLASH 133. The usage of VRAM and FLASH are merely exemplary. Other configurations and types of memory may be used.

The instruction set 120 is configured to instruct the graphic processor 110 to renderer 111 various components of the image 151 being shown on the display 150. As graphics are rendered, they are driven onto the display 150 by a display controller 112 (which performs the blending of planes to produce a final display output).

The above conventional architecture may be limited, due to available internal memory associated with the graphics processor 110. However, if more external memory is added, the problem is not addressed, due to constraints on available bandwidth.

### SUMMARY

A method and system for multi-frame buffering is disclosed herein. Further, methods for implementing and augmenting existing graphics processor, including those employed in the vehicular space (i.e. instrument clusters) is also disclosed.

A system for multiple-frame buffering for graphically rendering a data set of images is disclosed herein. The system includes rendering a first set of image data every frame on a display; and rendering a second set of image data every other frame on the display; wherein the first set of image data is sourced from an external non-volatile memory, and temporarily buffered in an internal dynamic memory every frame, and the second set of image data is sourced from the external non-volatile memory, and temporarily buffered in the internal dynamic memory in a first frame, and moved to and temporarily buffered into a second frame in a second frame.

In another example, the system includes rendering of the first set of image reading a new graphic element from the first set of image data from the external non-volatile memory via a graphics processor; rendering, via a display controller integrated via the graphics processor, information previously stored in a second frame buffer of the internal dynamic memory, copying a previously stored graphic element in the first frame to the second frame buffer, and storing the new graphic element into the first frame buffer.

Also includes is a method for augmenting a graphic processor with external dynamic memory. The method includes installing, via the graphic processor, a coupling to the external dynamic memory; receiving graphical assets via an external data store to render via the graphical processor, onto a display; demarcating the graphical assets as either being rendered every frame, or every other frame; and modifying an instruction set employed to control the graphic processor, so that the graphical assets render every other frame are temporarily stored in a frame buffer in the external dynamic memory.

### BRIEF DESCRIPTION OF THE DRAWINGS

The detailed description refers to the following drawings, in which like numerals refer to like items, and in which:

FIG. 1 illustrates an example of a system for graphics processing and rendering for an application, such as a display for an instrument cluster.

FIG. 2 illustrates a block-level diagram of the architecture disclosed herein.

FIGS. 3 and 4 illustrate the operation of the system shown in FIG. 2 for data rendered every frame and every other frame, respectively.

FIG. 5 illustrates a method of operating the system shown in FIG. 2, and specifically implemented in the instruction set for controlling the graphical processor.

FIG. 6 illustrates a method of implementing the aspects disclosed herein.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

As explained in the Background section, graphics processors 110 are encoded and included with various instruction sets 110 to facilitate in the interplay of available memory, graphics rendering, and displaying. However, the performance, quality, and engagement with a human machine interface associated with rendering images are often degraded due to available memory and lack of bandwidth.

Thus, disclosed herein are methods and systems of incorporating external memory with multiple buffering to improve graphics rendering. Also disclosed herein is a methodology for employing the triple buffering and external memory, in a manner that allows for optimized graphics rendering while efficiently employing the additionally added resources.

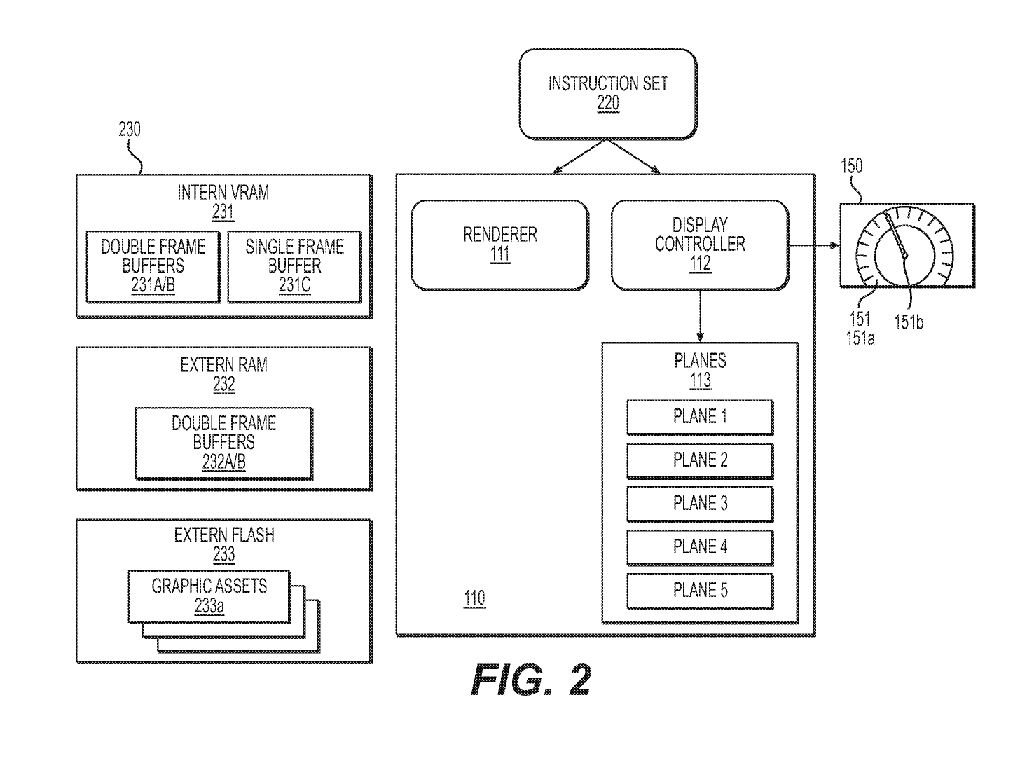

FIG. 2 illustrates a simplified explanation of the above-described concept. The system 200 shown in FIG. 2 will be shown with greater detail. As shown in FIG. 2, the instruction set 120 is modified (and shown as instruction set 220). The explanation of instruction set 220 (and specifically as to how a modification over the instruction set 120) will be explained with greater detail below.

Also modified in FIG. 2 is memory bank 130 (now shown as memory bank 230). One configuration of the memory bank 230 is shown, however, other configurations (for example, a single ROM may also be implemented). The various memory components in FIG. 2 will be also explained in greater detail below.

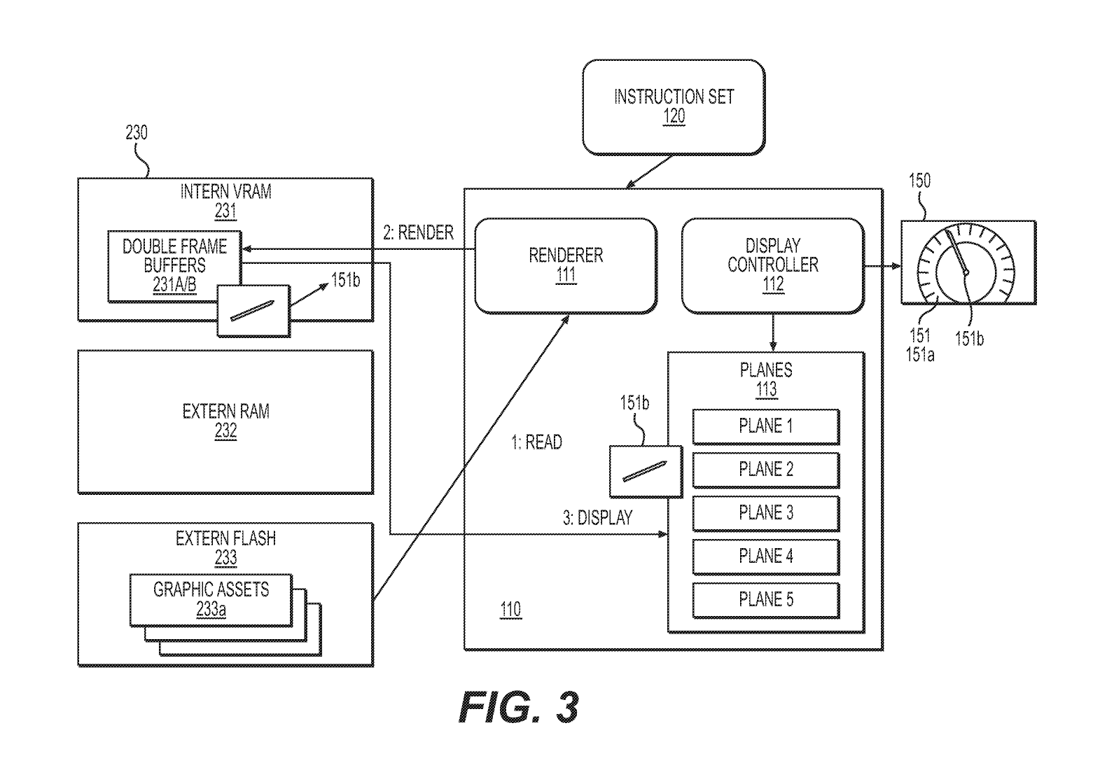

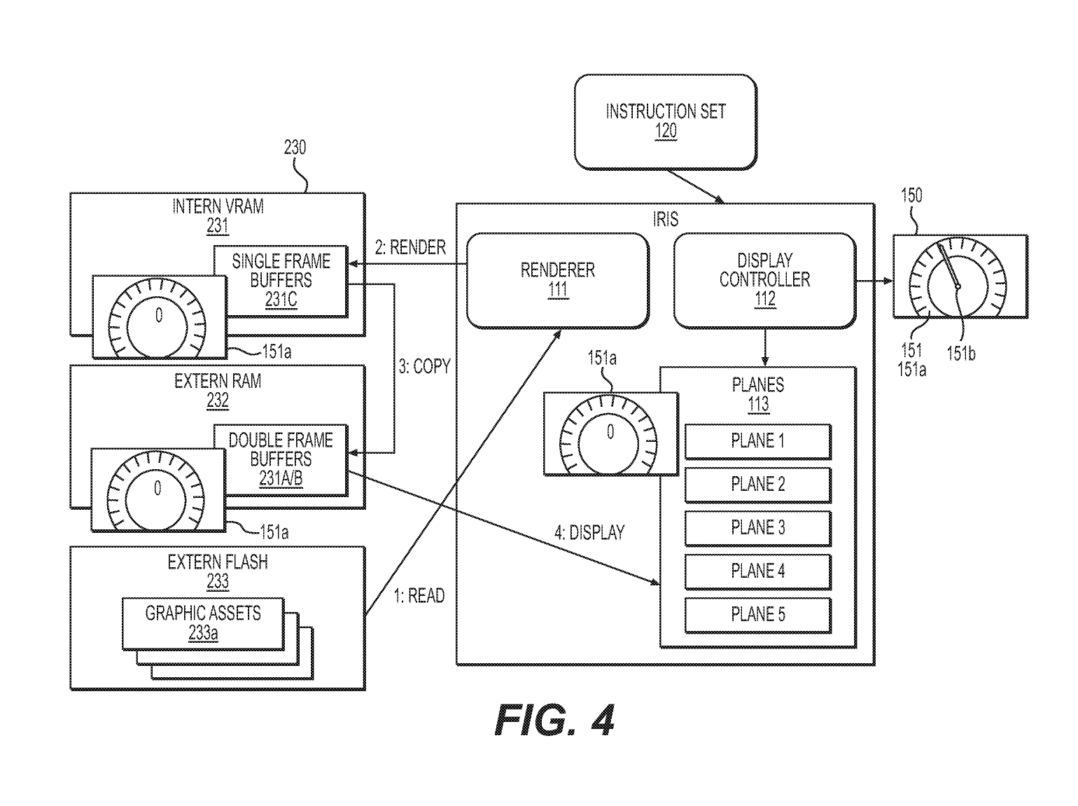

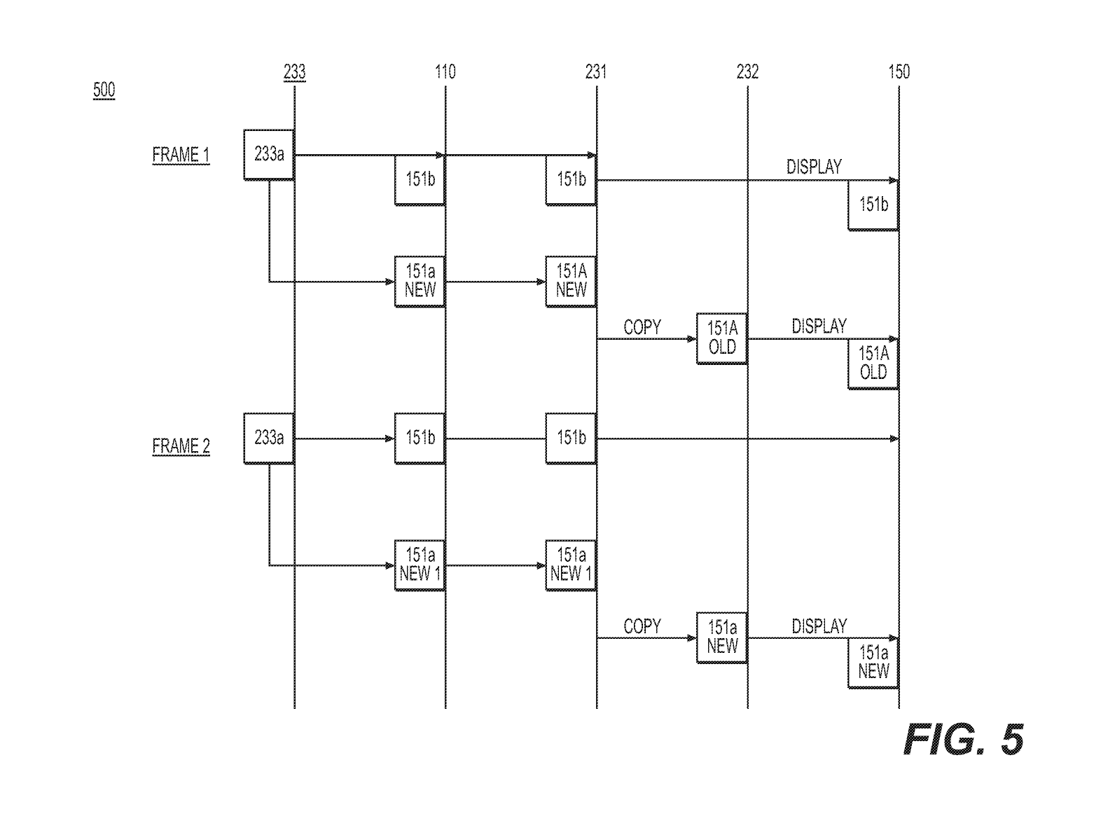

FIGS. 3 and 4 illustrate an example operation of system 200 according to a method 500 of operation. FIG. 5 illustrates an example flowchart of the method 500.

FIG. 3 illustrates an example of every frame with the system 200. FIG. 4 illustrates of the data pipelining associated with every two frames with the system 200. The essential concept of the architecture shown in FIG. 2 is that certain objects are re-rendered every frame, while other objects are rendered every two frames.

As shown in FIG. 3, in one operation, a graphical element 151b is a result of rendering of content copied from the memory bank 230, and stored into a first frame buffer 231a of the memory bank 230, for example the internal VRAM 231. In the same frame, a second frame buffer 231b is employed to store information to be propagated to the display controller 112. The display controller 112 drives the contents of frame buffer 231b to a display 150.

FIG. 4 illustrates the processing of images 151a every two frames. In FIG. 4, the data associate with image 151a is retrieved from the external FLASH 233. Concurrently, the image 151a is rendered, and stored in frame buffer 231c. In the first frame, the image 151a is copied to a first frame buffer 232a, and employed drive display 150 (via display controller 112). During one cycle (i.e. two display frames reserved for the displaying of image 151a), buffer 232a is used by the display controller 112 for displaying the image 151a. At the next cycle (next two display frames), buffer 232b is used to display the image 151, with 231a receiving a copy of the next frame of 151a as soon it has been rendered and stored in buffer 231c. In this way, the buffers 232a and b switch roles every cycle.

Thus, employing the concepts disclosed above, the image 151 is efficiently propagated onto a display 150 in a manner that utilizes external RAM 232.

The applicants have shown that the systems and methods shown in FIGS. 3-5, when employed in an instrument cluster, lead to implementations where digital elements like pointers are produced in a manner that is more reflective of real-time changes associated with rendering of the GUI. For example, if a pointer is rendered employing the concepts described herein, and speed of the pointer being displayed (and ultimately rendered), may be closely tied to a sensor associated with the indication of where the pointer should be rendered to.

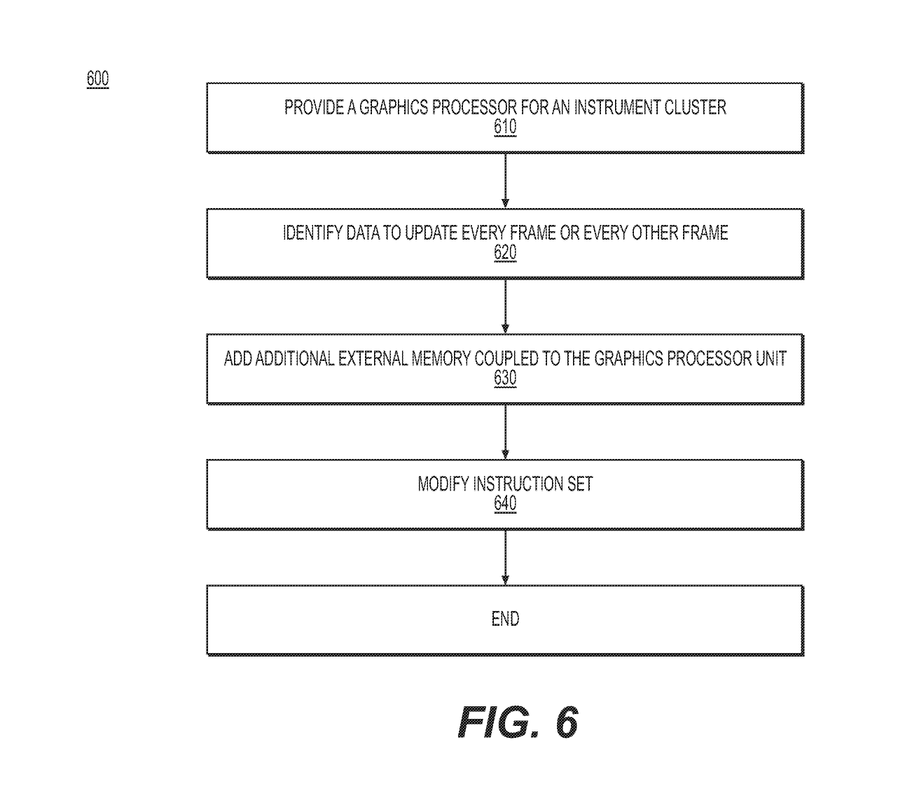

FIG. 6 illustrates an implementation of a method 600 for employing the systems described herein.

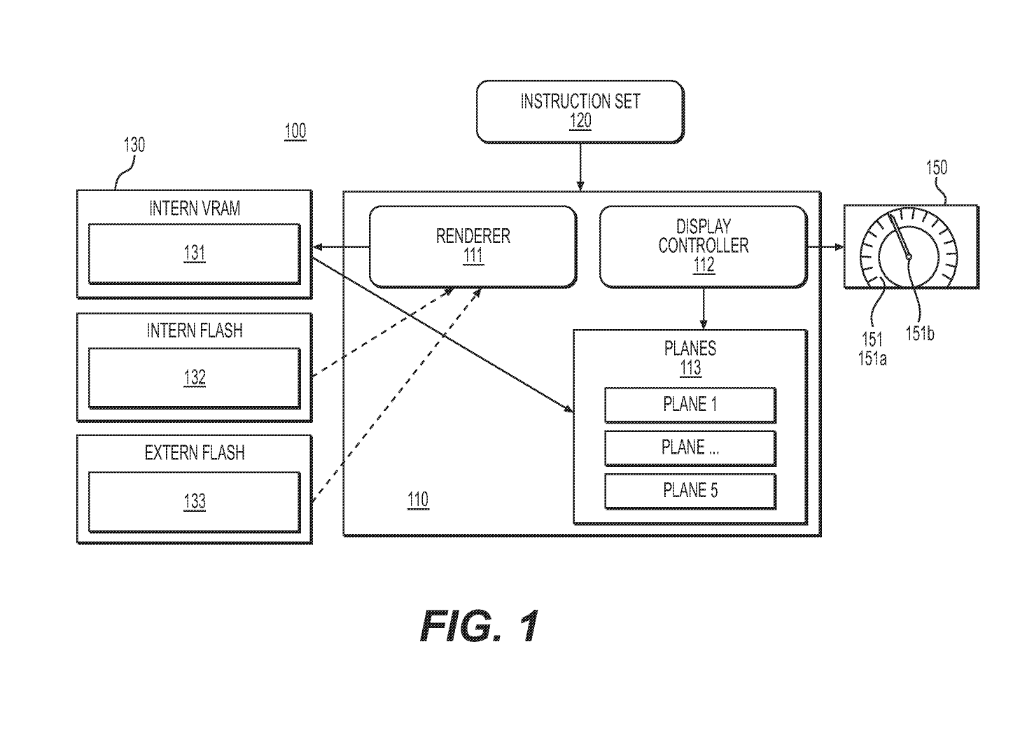

In operation 610, a graphics processor, such as those shown in FIGS. 1-4 is provided (processor 110). This graphics processor may be implemented along with a variety of display systems, employed to display information to a user. In one example, the processor 110 may be employed in an instrument cluster in a vehicle.

In operation 620, information is demarcated, and identified as graphical assets that are updated every frame, or every other frame. This demarcation may occur through a deliberate selection, or based on a rule. In the example described herein, where a digital instrument cluster is employed, graphical assets that reflect a current operation of a vehicle (i.e. a speed sensor, a revolutions per minute (RPM) sensor, a fuel usage sensor, or the like) may be associated with “every frame” rendering, while graphics associated with non-dynamic or vehicle sensor operations may be updated every other frame.

As shown in FIGS. 2-4, an additional external dynamic RAM is provided, and situated to allow the multiframe buffering described herein (operation 630). In operation 640, an instruction set (i.e. information incorporate into a microprocessor or microcontroller) is modified to employ the method 500 described above.

Thus, employing the aspects disclosed herein, an existing graphics processor and an existing instruction set may be modified to employ a triple buffering scheme to variably provide rendered images a display. As experimentally tested, by employing the aspects disclosed herein, graphics rendering is improved for various applications, such as instrument cluster displays.

Certain of the devices shown include a computing system. The computing system includes a processor (CPU) and a system bus that couples various system components including a system memory such as read only memory (ROM) and random access memory (RAM), to the processor. Other system memory may be available for use as well. The computing system may include more than one processor or a group or cluster of computing system networked together to provide greater processing capability. The system bus may be any of several types of bus structures including a memory bus or memory controller, a peripheral bus, and a local bus using any of a variety of bus architectures. A basic input/output (BIOS) stored in the ROM or the like, may provide basic routines that help to transfer information between elements within the computing system, such as during start-up. The computing system further includes data stores, which maintain a database according to known database management systems. The data stores may be embodied in many forms, such as a hard disk drive, a magnetic disk drive, an optical disk drive, tape drive, or another type of computer readable media which can store data that are accessible by the processor, such as magnetic cassettes, flash memory cards, digital versatile disks, cartridges, random access memories (RAMs) and, read only memory (ROM). The data stores may be connected to the system bus by a drive interface. The data stores provide nonvolatile storage of computer readable instructions, data structures, program modules and other data for the computing system.

To enable human (and in some instances, machine) user interaction, the computing system may include an input device, such as a microphone for speech and audio, a touch sensitive screen for gesture or graphical input, keyboard, mouse, motion input, and so forth. An output device can include one or more of a number of output mechanisms. In some instances, multimodal systems enable a user to provide multiple types of input to communicate with the computing system. A communications interface generally enables the computing device system to communicate with one or more other computing devices using various communication and network protocols.

Embodiments disclosed herein can be implemented in digital electronic circuitry, or in computer software, firmware, or hardware, including the herein disclosed structures and their equivalents. Some embodiments can be implemented as one or more computer programs, i.e., one or more modules of computer program instructions, encoded on a tangible computer storage medium for execution by one or more processors. A computer storage medium can be, or can be included in, a computer-readable storage device, a computer-readable storage substrate, or a random or serial access memory. The computer storage medium can also be, or can be included in, one or more separate tangible components or media such as multiple CDs, disks, or other storage devices. The computer storage medium does not include a transitory signal.

As used herein, the term processor encompasses all kinds of apparatus, devices, and machines for processing data, including by way of example a programmable processor, a computer, a system on a chip, or multiple ones, or combinations, of the foregoing. The processor can include special purpose logic circuitry, e.g., an FPGA (field programmable gate array) or an ASIC (application-specific integrated circuit). The processor also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, module, engine, software, software application, script, or code) can be written in any form of programming language, including compiled or interpreted languages, declarative or procedural languages, and the program can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

To provide for interaction with an individual, the herein disclosed embodiments can be implemented using an interactive display, such as a graphical user interface (GUI). Such GUI's may include interactive features such as pop-up or pull-down menus or lists, selection tabs, scannable features, and other features that can receive human inputs.

The computing system disclosed herein can include clients and servers. A client and server are generally remote from each other and typically through a communications network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for multiple-frame buffering for graphically rendering a data set of images, comprising:
a data store comprising a non-transitory computer readable medium storing a program of instructions for the implementation of the sorted linked list;
a processor that executes the program of instructions, the instruction comprising the following steps:
rendering a first set of image data every frame on a display; and rendering a second set of image data every other frame on the display; wherein the first set of image data is sourced from an external non-volatile memory, and temporarily buffered in an internal dynamic memory every frame, and
the second set of image data is sourced from the external non-volatile memory, and temporarily buffered in the internal dynamic memory in a first frame, and moved to and temporarily buffered into a second frame in a second frame.

2. The system according to claim 1, wherein the rendering of the first set of image data further comprises:
reading a new graphic element from the first set of image data from the external non-volatile memory via a graphics processor;
rendering, via a display controller integrated via the graphics processor, information previously stored in a second frame buffer of the internal dynamic memory,
copying a previously stored graphic element in the first frame to the second frame buffer, and
storing the new graphic element into the first frame buffer.

3. The system according to claim 1, wherein the rendering of the second set of image data further comprises:
reading a new graphical element from the second set of image data from the external non-volatile memory via a graphics processor;
rendering, via a display controller, the new graphical element, into a frame buffer of the external non-volatile memory;
copying from the frame buffer, a previously stored graphical element to a first frame buffer of the external dynamic memory; and
displaying from a second frame of the external dynamic memory, stored data.

4. The system according to claim 2, wherein the rendering of the second set of image data further comprises:
reading a new graphical element from the second set of image data from the external non-volatile memory via a graphics processor;
rendering, via a display controller, the new graphical element, into a third frame buffer of the external non-volatile memory;
copying from the frame buffer, a previously stored graphical element to a first frame buffer of the external dynamic memory; and
displaying from a second frame of the external dynamic memory, stored data.

5. The system according to claim 4, wherein the first set of image data is foreground information, and the second set of image data is background information.

6. The system according to claim 4, wherein the first set of image data is based on a sensor, and the second set of image data is based on information independent the sensor.

7. The system according to claim 6, wherein the sensor is associated with an operation of a vehicle during a driving condition.

8. The system according to claim 7, wherein the first set of image data relates to a graphical user interface of a pointer.

9. A method for augmenting a graphic processor with external dynamic memory, comprising:
installing, via the graphic processor, a coupling to the external dynamic memory;
receiving graphical assets via an external data store to render via the graphical processor, onto a display;
demarcating the graphical assets as either being rendered every frame, or every other frame; and
modifying an instruction set employed to control the graphic processor, so that the graphical assets render every other frame are temporarily stored in a frame buffer in the external dynamic memory.
